(19) United States
(12) Patent Application Publication
(10) Pub. No.: US 2020/0193989 A1
(43) Pub. Date: Jun. 18, 2020

(54) AUDIO DEVICE AND CONTROL METHOD THEREFOR

(71) Applicant: LG ELECTRONICS INC., Seoul (KR)

(72) Inventor: Gyuhyeok JEONG, Seoul (KR)

(73) Assignee: LG ELECTRONICS INC., Seoul (KR)

(21) Appl. No.: 16/607,671

(22) PCT Filed: May 18, 2017
(86) PCT No.: PCT/KR2017/005168

§ 371 Date: Oct. 23, 2019

(30) Foreign Application Priority Data
Apr. 24, 2017 (KR) 10-2017-0052190

(51) Int. Cl. G10L 15/22; G10L 15/06; G10L 25/51; G10L 15/30; G06F 3/16; H04L 12/28; G08B 5/36; G06N 20/00; G06N 5/04

(52) U.S. Cl. CPC G10L 15/22; G10L 15/063; G10L 25/51; G10L 15/30; G10L 2015/223; H04L 12/2803; G08B 5/36; G06N 20/00; G06N 5/04; G06F 3/167

(57) ABSTRACT

The present invention relates to an audio device for performing speech recognition using artificial intelligence, and a control method therefor. In order to achieve such or other purposes, provided is an audio device, according to one aspect of the present invention, comprising: an artificial intelligence unit for learning history information associated with first non-natural language audio data; a microphone for receiving the first non-natural language audio data; and a wireless communication unit for transmitting/receiving data to/from at least one device, wherein the artificial intelligence unit determines a configuration mode for a home network including the at least one device so as to correspond to the received first non-natural language audio data, and on the basis of the determined configuration mode, a control unit controls so that a control signal is transmitted to the at least one device via the wireless communication unit, wherein the first non-natural language audio data is audio data excluding natural language audio data which is language data used for human communication.

### TECHNICAL FIELD

The present disclosure relates to an audio device for performing speech recognition using artificial intelligence and a method for controlling the same.

### BACKGROUND ART

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As such functions become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device.

Efforts are ongoing to support and increase the functionality of mobile terminals. Such efforts include software and hardware improvements, as well as changes and improvements in the structural components.

Recently, a field of an artificial intelligence technology that enables thinking similar to human intelligence is rapidly developing based on a machine learning technology. Such artificial intelligence may enable a machine to substitute for a human action of manipulating the machine through conventional human thinking. Thus, there are various movements for utilizing the artificial intelligence in various industries.

Recently, as an example of the mobile terminal, an audio device capable of speech recognition has been developed. The audio device, which is a device having a speaker system, may be configured to recognize a speech and perform an operation associated with the speech. In addition, the audio device may be in communication with home appliances, which are connected with each other through communication, to control the home appliances. Thus, a user may conveniently perform various functions simply by talking to the audio device.

Further, the audio device may be formed to receive audio data including natural language, which is a language commonly used by humans, and execute a function associated with the received audio data. However, the audio device may be required to execute a function associated with audio data that is not a language used by the humans.

### DISCLOSURE

### Technical Problem

One purpose of the present disclosure is to solve the above-mentioned and other problems. Another purpose of the present disclosure is to use artificial intelligence to enable speech recognition of a non-natural language, which is not a natural language.

In addition, still another purpose of the present disclosure is to provide a more efficient environment for a user by recognizing surrounding sounds even when there is no direct operation or speech control from the user.

### Technical Solutions

One aspect of the present disclosure proposes an audio device including an artificial intelligence unit for learning history information associated with first non-natural language audio data, a microphone for receiving the first non-natural language audio data, a wireless communication unit for transmitting/receiving data to/from at least one device, and a controller, wherein the artificial intelligence unit determines a setting mode for a home network including the at least one device, in response to the received first non-natural language audio data, wherein the controller controls the wireless communication unit to transmit a control signal to the at least one device based on the determined setting mode, and wherein the first non-natural language audio data is audio data excluding natural language audio data, and wherein the natural language audio data is language data used for human communication.

In one implementation, the artificial intelligence unit may further determine the setting mode for the home network including the at least one device when the first non-natural language audio data is received for a preset time.

In one implementation, the artificial intelligence unit may further, when second non-natural language audio data is received after the setting mode of the home network is changed, determine to cancel the changed setting mode of the home network and return to a previous home network setting mode.

In one implementation, the artificial intelligence unit may further determine the setting mode for the home network including the at least one device in response to the received first non-natural language audio data and a time when the first non-natural language audio data is received.

In one implementation, the artificial intelligence unit may further, when third non-natural language audio data is received after the setting mode of the home network is changed, transmit a notification to a mobile terminal of a user through the wireless communication unit.

In one implementation, the artificial intelligence unit may further learn history information associated with the non-natural language audio data corresponding to the received first non-natural language audio data, and determine a current situation of the home network and determine the setting mode for the home network based on the history information.

In one implementation, the artificial intelligence unit may further generate audio feedback in response to the received first non-natural language audio data.

In one implementation, the audio device may further include a speaker, wherein the controller may further output the audio feedback through the speaker.

In one implementation, the artificial intelligence unit may further receive additional natural language audio data after the audio feedback is output, and transmit the control signal to the at least one device based on the received additional natural language audio data.

In one implementation, the artificial intelligence unit may further determine the setting mode of the home network including the at least one device based on weather information corresponding to geographical information of the home network.

In one implementation, the microphone may be driven in an always on state.

In one implementation, the at least one device included in the home network may include at least one of a door lock, a gas lock, an air conditioner, a temperature controller, a window sensor, a hot-air blower, a television, or a lamp.

In one implementation, the changed setting mode of the home network may include at least one of an away mode, a security mode, or a sleep mode.

In one implementation, the audio device may further include an optical output module, wherein the controller may further output a color of notification information corresponding to the changed setting mode of the home network through the optical output module.

Another aspect of the present disclosure proposes a method for controlling an audio device, the method including learning history information associated with non-natural language audio data received from the audio device, receiving first non-natural language audio data, determining a setting mode for a home network including at least one device, in response to the received first non-natural language audio data, and controlling a wireless communication unit to transmit a control signal to the at least one device based on the determined setting mode, wherein the first non-natural language audio data is audio data excluding natural language audio data, and wherein the natural language audio data is language data used for human communication.

### Advantageous Effects

Effects of the audio device and the method for controlling the same according to the present disclosure are as follows.

According to at least one of embodiments of the present disclosure, a device included in a network to which a current audio device belongs may be controlled through non-natural language audio data.

Further, according to at least one of embodiments of the present disclosure, even when there is no direct control of the user, an environment to which the audio device belongs may be controlled.

A further scope of the applicability of the present disclosure will become apparent from a detailed description below. However, since various changes and modifications within the spirit and scope of the present disclosure may be clearly understood by those skilled in the art, it should be understood that a specific description and a specific embodiment such as a preferred embodiment of the present disclosure are given by way of example only.

### DESCRIPTION OF DRAWINGS

FIG. 1 is a block diagram of a mobile terminal in accordance with the present disclosure.

FIGS. 2A and 2B illustrate an example of an audio device.

FIG. 3 is a diagram illustrating an example of an artificial intelligence (AI) system including an audio device according to one embodiment of the present disclosure.

FIG. 4 is a flowchart illustrating a method for controlling an audio device according to one embodiment of the present disclosure.

FIG. 5 is a flowchart illustrating a method for controlling an audio device according to one embodiment of the present disclosure.

FIG. 6 illustrates an example of controlling at least one device based on non-natural language audio data through an audio device according to one embodiment of the present disclosure.

FIG. 7 illustrates another example of controlling at least one device based on non-natural language audio data through an audio device according to one embodiment of the present disclosure.

FIG. 8 is a flowchart illustrating a method for controlling an audio device according to one embodiment of the present disclosure.

FIG. 9 illustrates an example of controlling at least one device based on non-natural language audio data and natural language audio data in an audio device according to one embodiment of the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

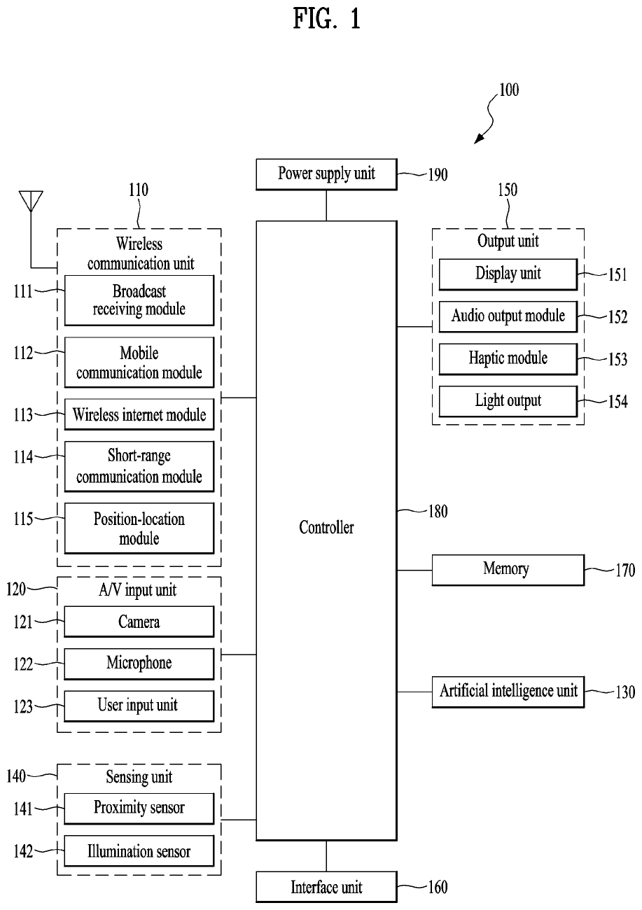

FIG. 1 is a block diagram of a mobile terminal in accordance with the present disclosure.

The mobile terminal 100 is shown having components such as a wireless communication unit 110, an input unit 120, artificial intelligence unit 130, sensing unit 140, an output unit 150, an interface unit 160, a memory 170, a controller 180, and a power supply unit 190. It is understood that implementing all of the illustrated components in The FIG. 1 is not a requirement, and that greater or fewer components may alternatively be implemented.

More specifically, the wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The artificial intelligence unit 130, which performs a role of processing information based on an artificial intelligence technology, may include at least one module that performs at least one of learning information, inferring information, perceiving information, and processing natural language.

The artificial intelligence unit 130 may perform, using a machine learning technology, at least one of learning, inferring, and processing a large amount of information (big data) such as information stored in the mobile terminal, environment information around the mobile terminal, information stored in communicable external storage. Further, the artificial intelligence unit 130 may predict (or infer) at least one feasible operation of the mobile terminal using the information learned using the machine learning technology and control the mobile terminal such that the most feasible operation among the at least one predicted operation is executed.

The machine learning technology is a technology that collects and learns a large amount of information based on at least one algorithm, and determines and predicts information based on the learned information. The learning of the information is an operation of grasping features, rules, judgment criteria, and the like of the information, quantifying a relationship between the information, and predicting new data using a quantized pattern.

The algorithms used by such machine learning technology may be algorithms based on statistics, and may include a decision tree that uses a tree structure shape as a prediction model, an artificial neural network that mimics structure and function of a neural network of an organism, genetic programming based on an evolution algorithm of an organism, clustering that distributes observed examples into subsets called clusters, a Monte carlo method that calculates a function value into a probability through randomly extracted random numbers, and the like, as an example.

As a field of the machine learning technology, a deep learning technology is a technology that performs at least one of learning, determining, and processing information by using an artificial neural network algorithm. The artificial neural network may have a structure that connects layers and transfers data between the layers. In such deep learning technology, a huge amount of information may be learned through the artificial neural network using a graphics processing unit (GPU) optimized for parallel computing.

Further, the artificial intelligence unit 130 may collect (sense, monitor, extract, detect, and receive) a signal, data, information, and the like input to or output from components of the mobile terminal to collect the huge amount of information to apply the machine learning technology. In addition, the artificial intelligence unit 130 may collect (sense, monitor, extract, detect, and receive) data, information, and the like stored in the external storage (e.g., a cloud server) connected through communication. More specifically, the collection of the information may be understood as a term including an operation of sensing the information through a sensor, extracting information stored in the memory 170, or receiving information from the external storage through the communication.

The artificial intelligence unit 130 may detect information in the mobile terminal, information on surrounding environment surrounding the mobile terminal, and user information through the sensing unit 140. In addition, the artificial intelligence unit 130 may receive a broadcast signal and/or broadcast related information, a wireless signal, wireless data, and the like through the wireless communication unit 110. In addition, the artificial intelligence unit 130 may receive image information (or signal), audio information (or signal), data, or information input from the user from the input unit.

Such artificial intelligence unit 130 may collect the large amount of information in real time in a background and learns the collected large amount of information to store information processed in an appropriate form (e.g., a knowledge graph, a command policy, a personalized database, a conversation engine, etc.) in the memory 170.

Further, based on the information learned using the machine learning technology, when the operation of the mobile terminal is predicted, the artificial intelligence unit 130 may control the components of the mobile terminal or transmit a control command to the controller 180 to execute the predicted operation in order to execute such predicted operation. The controller 180 may execute the predicted operation by controlling the mobile terminal based on the control command.

Further, when a specific operation is performed, the artificial intelligence unit 130 may analyze history information indicating the performance of the specific operation through the machine learning technology, and update the existing learned information based on such analysis information. Thus, the artificial intelligence unit 130 may improve an accuracy of the information prediction.

Further, in the present specification, the artificial intelligence unit 130 and the controller 180 may be understood as the same component. In this case, a function performed by the controller 180 to be described herein may be expressed as being performed by the artificial intelligence unit 130. The controller 180 may be referred to as the artificial intelligence unit 130, and on the contrary, and the artificial intelligence unit 130 may be referred to as the controller 180.

Alternatively, in the present specification, the artificial intelligence unit 130 and the controller 180 may be understood as separate components. In this case, the artificial intelligence unit 130 and the controller 180 may perform various controls on the mobile terminal through data exchange therebetween. The controller 180 may perform at least one function on the mobile terminal or control at least one of the components of the mobile terminal based on a result derived from the artificial intelligence unit 130. Furthermore, the artificial intelligence unit 130 may also be operated under the control of controller 180.

The sensing unit 140 is typically implemented using one or more sensors configured to sense internal information of the mobile terminal, the surrounding environment of the mobile terminal, user information, and the like. For example, the sensing unit 140 may alternatively or additionally include other types of sensors or devices, such as a proximity sensor 141 and an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output, or activating application programs stored in the memory 170.

To drive the application programs stored in the memory 170, the controller 180 may be implemented to control a predetermined number of the components mentioned above in reference with FIG. 1A. Moreover, the controller 180 may be implemented to combinedly operate two or more of the components provided in the mobile terminal 100 to drive the application programs.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Some or more of the components may be operated cooperatively to embody an operation, control or a control method of the mobile terminal in accordance with embodiments of the present disclosure. Also, the operation, control or control method of the mobile terminal may be realized on the mobile terminal by driving of one or more application problems stored in the memory 170.

Hereinafter, referring to FIG. 1, the components mentioned above will be described in detail before describing the various embodiments which are realized by the mobile terminal 100 in accordance with the present disclosure.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data associated with the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information associated with a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sensing unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output associated with a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data associated with various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 may be provided with the power supplied by an external power source and the power supplied therein under the control of the controller 180 so as to supply the needed power to each of the components. The power supply unit 190 may include a battery. The battery may be a built-in type which is rechargeable and detachably loaded in the terminal to be charged.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Hereinafter, embodiments associated with a control method that may be implemented in the audio device configured as described above will be described with reference to the accompanying drawings. It will be apparent to those skilled in the art that the present disclosure may be embodied in other specific forms without departing from the spirit and essential characteristics of the present disclosure.

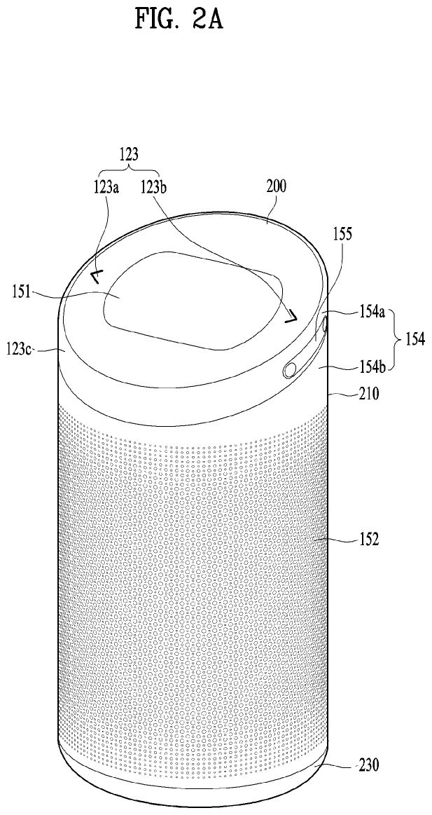

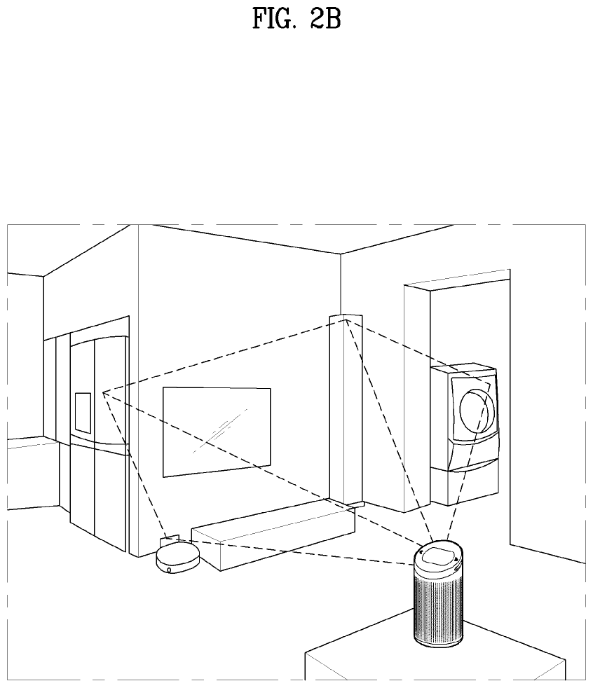

FIGS. 2A and 2B illustrate an example of an audio device.

An audio device 100 according to the present disclosure includes a speaker system for outputting audio data and is a mobile terminal capable of speech recognition. Hereinafter, for convenience of description, the term “mobile terminal” described with reference to FIG. 1 will be described as the term “audio device” 100. However, the present disclosure is not limited to the term “audio device” 100. Further, the present disclosure may be applied to various mobile terminals described with reference to FIG. 1.

The audio device 100 according to the present disclosure may include at least one components described with reference to FIG. 1. A description of the components of the audio device 100 is replaced with the description of FIG. 1.

Referring to FIG. 2A, the audio device 100 may include the user input unit 123, the audio output module 152, and the optical output module 154 on an outer face of a body 200. The user input unit 123 may be configured to receive the control command from the user, and may include a plurality of user input units. Hereinafter, the plurality of user input units will be described as a first user input unit 123a, a second user input unit 123b, and a third user input unit 123c, respectively. Similarly, the optical output module 154 may also include a plurality of optical output modules. Further, the plurality of optical output modules will be described as a first optical output module 154a and a second optical output module 154b, respectively. When collectively referring the plurality of user input units and optical output modules, the same will be described using reference numerals 123 and 154.

The body 200 may have a cylindrical shape and may have a function of a soundbox. Further, the body 200 may be determined in size in consideration of a design. Further, the shape of the body may be variously changed.

The body may include a first region 210 forming a side face of the cylinder, a second region 220 forming a bottom face of the cylinder, and a third region 230 formed to face the second region 220 and forming the other bottom face of the cylinder. The second region 220 and the third region 230 may have the same area or may have different areas.

The first region 210 may be referred to as an outer face, and the second region 220 and a third region 230 may be referred to as an outer top face and an outer bottom face, respectively. Hereinafter, a description will be made using the terms of the first, second, and third regions.

The first region 210 may include a third user input unit 123c, a second optical output module 154b, an infrared optical output module 155, and an audio output module 152. For example, the second optical output module 154b and the audio output module 152 may be formed to be spaced apart from each other. Alternatively, referring to FIG. 2A, at least a portion of the second optical output module 154b may form a layer structure with and overlap with the audio output module 152. This may be easily changed by a designer's design.

The second optical output module 154b and the audio output module 152 may be formed to surround the first region 210 of the body 200. Therefore, the audio output module 152 may be formed to output sound in all directions with respect to the body, and the second optical output module 154b may output light in all directions with respect to the body.

The third user input unit 123c may be disposed at a top of the first region 210. The third user input unit 123c may be formed to rotate about a center point of the body 200. Therefore, the user may rotate the third user input unit 123c to increase or decrease a volume of the audio device 100.

The infrared optical output module 155 may be disposed at a position where an infrared signal may be output in all directions. For example, the infrared optical output module may be disposed on the top of the first region 210. As another example, as shown in FIG. 2A, the infrared optical output module may be disposed in a region, defined to be rotatable, of the top of the first region 210. Therefore, the infrared optical output module 155 may output the infrared signal such that the infrared signal reaches an external device located at an arbitrary position. Further, the position of the infrared optical output module may be changed to a position where the infrared signal may be output in all directions by a design of those skilled in the art.

The display unit 151, the first and second user input units 123a and 123b, the first optical output module 154a, and a temperature/humidity sensor may be arranged in the second region 220.

The display unit 151 may be disposed at a center of the second region 220 such that the user may know a time. The first and second user input units 123a and 123b may be arranged in a peripheral region of the display unit 151 to receive a user input.

The first and second user input units 123a and 123b may be formed in a button type to operate by a pressing operation or may be formed in a touch type to operate by a touch operation. The first and second user input units 123a and 123b may be formed to perform different functions. For example, the first user input unit 123a may be a button for inputting a control command for stopping speech recognition, and the second user input unit 123b may be a button for inputting a control command for turning on/off power.

The first optical output module 154a may be formed along an edge of the second region 220. That is, the first optical output module 154a may have a band shape that surrounds the edge of the second region 220. For example, when the second region 220 is circular, the first optical output module 154a may have a band shape surrounding the circle.

The optical output module 154 may be formed to emit light from a light source. As such a light source, a light emitting diode (LED) may be used. The light source is located on an inner circumferential face of the optical output module 154, and the light output from the light source passes through the optical output module 154 to illuminate outside. The optical output module 154 is made of a transparent or translucent material through which the light may pass.

The optical output module 154 may output notification information associated with an event occurred in the audio device 100 as light. For example, when the speech recognition is being performed in the audio device 100, red light may be output. In addition, when the audio device 100 is waiting for a modification command, yellow light may be output.

The temperature/humidity sensor may be disposed in the second region 220 which may be in direct contact with the outside so as to sense external temperature and humidity.

Although not shown, the power supply unit 190 for receiving power from the outside, an interface unit 160 for transmitting and receiving data to/from the external device, and an audio input unit (microphone) for receiving sound, and the like may be further arranged in the third region 230.

Such audio device 100 may control the external devices through short-range wireless communication with the external devices. Referring to FIG. 2B, the audio device 100 may perform the short-range communication with electronic devices such as a refrigerator, a washing machine, a TV, an air conditioner, a robot cleaner, a door lock, a gas circuit breaker, a temperature controller, and a security system, dehumidifier, and the like that exist on the same home network as the audio device 100. The short-range wireless communication may include Wi-Fi, Bluetooth, Z-wave, infrared communication, and the like.

As an example in which the audio device 100 controls the external devices, the audio device 100 may turn on the air conditioner or adjust a temperature of the air conditioner through infrared communication.

As such, the audio device 100 may serve as a controller for controlling the external device under an Internet of Things (IoT) environment.

Hereinabove, the audio device 100 according to the present disclosure has been described. Although the above description shows an arrangement of the components of the audio device 100, the present disclosure is not limited thereto, and positions of the components may be changed within a range that may be easily changed by those skilled in the art.

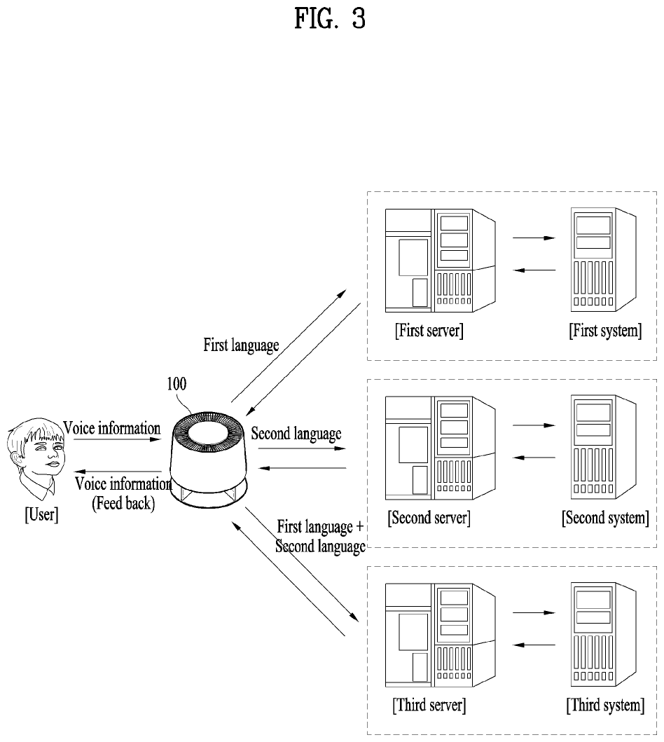

FIG. 3 is a diagram illustrating an example of an artificial intelligence (AI) system including an audio device according to one embodiment of the present disclosure.

When audio data is received, the artificial intelligence system may primarily determine a language in the audio device 100 and assign the language to the server, or alternatively, determine the language in the server other than the audio device 100.

As an example, the artificial intelligence system according to an embodiment of the present disclosure includes the audio device 100, a plurality of servers and a plurality of systems connected thereto. Further, the artificial intelligence system may determine the language of the received audio data in the audio device 100 and assign the language to each server and system, and provide feedback therefrom.

First, when the audio data is received from the user, the audio device 100 primarily determines the language of the audio data. The audio device 100 may determine the language of the received audio data, and allocate the audio data to a first server when the language of the audio data corresponds to a first language. In this connection, it is assumed that the first language is a native language. In this case, the first server may transmit a transcript corresponding to the audio data to a first system and receive an analysis result from the first system. Further, the server may transmit the analysis result to the audio device 100, and the audio device 100 may provide feedback as voice information to the user.

In one example, when the language of the audio data corresponds to a second language, the audio device 100 may allocate the audio data to a second server. In this connection, it is assumed that the second language is a foreign language. In this case, the second server may transmit a transcript corresponding to the audio data to a second system and receive an analysis result from the second system. Further, the server may transmit the analysis result to the audio device 100, and the audio device 100 may provide feedback as voice information to the user.

In addition, when the language of the audio data is a combination of the first language and the second language, the audio device 100 may allocate the audio data to a third server. In this case, the third server may transmit a transcript corresponding to the audio data to a third system and receive an analysis result from the third system. Further, the server may transmit the analysis result to the audio device 100, and the audio device 100 may provide feedback as voice information to the user.

As another example, although not shown in FIG. 3, the artificial intelligence system according to an embodiment of the present disclosure may include the audio device 100 and at least one server and system connected thereto. In this case, unlike the above, the language of the received audio data may be directly transmitted to the server without being determined in the audio device 100 to provide feedback received from the server and the system to the user.

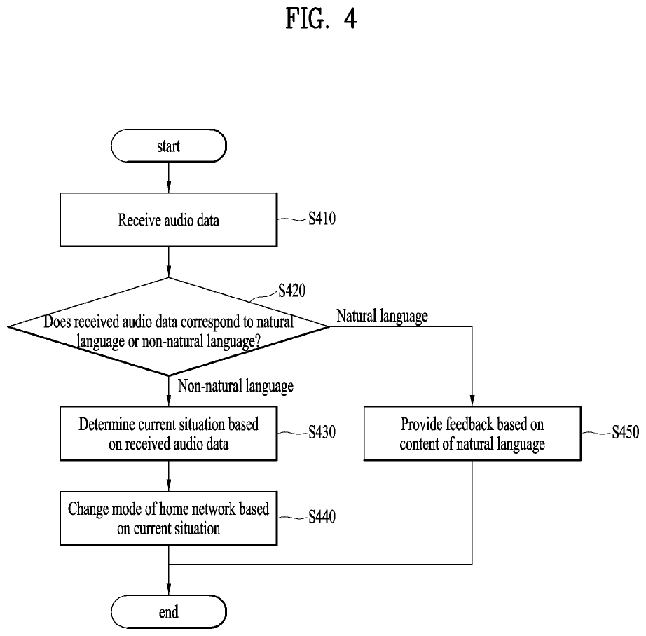

Hereinafter, in FIGS. 4 to 9, a method for performing a predicted operation using the above-described artificial intelligence system when non-natural language audio data is received through the audio device will be described.

The audio data received through the audio device may include natural language audio data and non-natural language audio data. In this connection, natural language corresponds to a language that people use to communicate on a daily basis. For example, the natural language may be extracted through a hierarchical language model, a statistical language model, a grammar, or the like. In addition, through the same, the natural language may assign a probability to an order of words by probability distribution and predict a next word of an order of voice.

In contrast, non-natural language may be extracted from an acoustic model configured to distinguish sound units. In addition, the non-natural language may be used in a state in which each of the sound units has been learned and intellectualized by the deep learning technology. In addition, the non-natural language may correspond to audio data except for the natural language. For example, the non-natural language may include noise generated in everyday life, sounds of nature, non-language sounds generated by humans, noise equal to or below a predetermined volume (e.g., silence), and the like.

Further, in general, when the natural language audio data is received, the audio device performs natural language processing (NLP) to grasp an intention of the user. The natural language processing corresponds to a task of transforming everyday language through form analysis, meaning analysis, dialogue analysis, and the like such that the everyday language may be processed by a computer. However, even when the non-natural language audio data, which is not the natural language, is received through the audio device, it may be required to grasp a situation and an environment of a place where the audio device is located and to perform an operation related thereto. Thus, in the present disclosure, a method for controlling at least one device included in the home network appropriately for the situation or the environment by determining the situation or environment through the artificial intelligence system when the non-natural language audio data is received will be described.

Further, the audio device 100 according to the present disclosure may store a speech recognition application associated with the speech recognition function in the memory 170. Such a speech recognition application may perform the speech recognition through a database provided on its own, or may perform the speech recognition through a database provided on a server connected through communication.

In a following embodiment, the artificial intelligence unit 130 may drive the sensors, such as the microphone, temperature sensor, humidity sensor, and the like, for monitoring situation information in the background in real time. That is, the sensors may detect the information from the above-described sensors in real time from a time when the power of the audio device 100 is turned on to a time when the power of the audio device 100 is turned off. It is assumed that, in the present disclosure, a scheme for driving the above-described sensors is an always on driving scheme.

In addition, in the present disclosure, when the non-natural language audio data is received, the controller 180 may control the artificial intelligence unit 130 to monitor or determine the situation information or environmental information. In a following description, it will be described that the artificial intelligence unit 130 is operated under the control of the controller 180. However, the present disclosure is not limited thereto, and the controller 180 may replace the role of the artificial intelligence unit 130, and the artificial intelligence unit 130 may replace the role of the controller 180.

FIG. 4 is a flowchart illustrating a method for controlling an audio device according to one embodiment of the present disclosure.

More specifically, FIG. 4 illustrates a method for controlling the non-natural language audio data or the natural language audio data when the non-natural language audio data or the natural language audio data is received through the audio device.

The artificial intelligence unit 130 may receive the audio data (S410). For example, the audio data may be received through the microphone provided in the audio device.

In addition, the artificial intelligence unit 130 may determine whether the received audio data corresponds to the natural language or the non-natural language (S420). As mentioned above, the natural language audio data may represent a language that people use to communicate with each other on a daily basis, and the non-natural language audio data, which is audio data excluding the natural language audio data, may correspond to the noise generated in the everyday life, the sounds generated by the humans, the sounds generated in the nature, and the like.

When the audio data received in S520 corresponds to the non-natural language, the artificial intelligence unit 130 may determine the current situation or environment based on the information included in the non-natural language audio data (S430). In this connection, the artificial intelligence unit 130 may learn situation history information or environment history information stored in the memory 170 based on the machine learning or deep learning technology. In addition, the artificial intelligence unit may learn the situation history information or environment history information, and determine the current situation or current environment based on the learning results.

Next, the artificial intelligence unit 130 may change a setting mode of the home network including at least one linked device based on the current situation (S440). Alternatively, the artificial intelligence unit 130 may maintain or reset the setting mode of the home network based on the current situation. In addition, the controller 180 may transmit a control signal to the at least one linked device based on the changed home network mode.

Further, in the case of the present disclosure, in determining the setting mode of the home network when the non-natural language, which does not correspond to the human language, is received, the setting mode of the home network determined based on the non-natural language audio data may include an away mode (security mode) and a sleep mode. For example, the away mode (security mode), which is regarded as a state in which there is no person inside the house, corresponds to a state in which a sound of the device included in the home network, a horn sound of a vehicle, a pet sound, and the like, which are not the human language, are received. In addition, the sleep mode, which is a state in which the human language is not received at a preset time period, corresponds to a state in which the natural language data is not received even when the person is inside the house. In addition, the setting mode of the home network is not limited thereto. The setting mode may be variously classified and set.

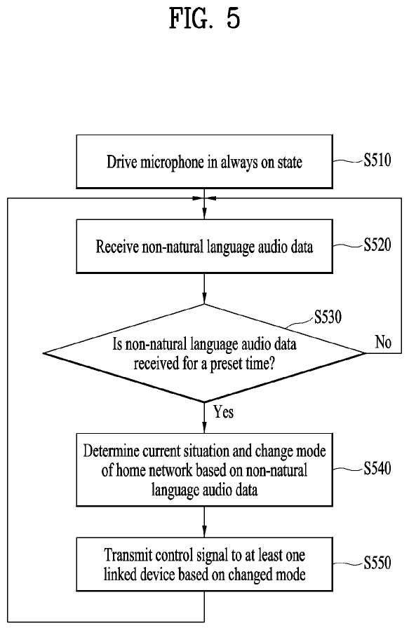

In this regard, a description will be followed through various embodiments with reference to FIGS. 5 to 9.

Further, when the audio data received in S420 corresponds to the natural language, the artificial intelligence unit 130 may provide the feedback based on content of the natural language (S450). In this connection, the artificial intelligence unit 130 may provide the feedback through the artificial intelligence system in FIG. 3 described above. In addition, when the artificial intelligence unit 130 receives the natural language audio data, the natural language audio data may be analyzed based on a preset algorithm. The preset algorithm is a conventionally known speech recognition algorithm, which is obvious to those skilled in the art, and thus a description thereof will be omitted.

Controlling the Home Network Based on the Non-Natural Language Audio Data

Hereinafter, a method for controlling the at least one linked device included in the home network based on a non-natural language audio signal will be described with reference to FIGS. 5 to 7.

FIG. 5 is a flowchart illustrating a method for controlling an audio device according to one embodiment of the present disclosure.

The microphone of the audio device may be driven in an always on state (S510). As described above, the microphone of the audio device may detect the audio data in real time.

In addition, the artificial intelligence unit 130 may receive the non-natural language audio data (S520). More specifically, the artificial intelligence unit 130 may receive the non-natural language audio data received through the microphone.

Next, the artificial intelligence unit 130 may determine whether the non-natural language audio data is received for a preset time (S530). When the non-natural language audio data is not received for the preset time, the audio device may continue to receive the non-natural language audio data.

When the non-natural language audio data is received for the preset time, the artificial intelligence unit 130 may determine the current situation and change the setting mode of the home network based on the non-natural language audio data (S540). In this regard, the artificial intelligence unit 130 may learn the situation history information or the environment history information stored in the memory 170 based on the machine learning technology. In addition, the artificial intelligence unit 130 may learn the situation history information or the environment history information, and determine the current situation or the current environment based on the learning result.

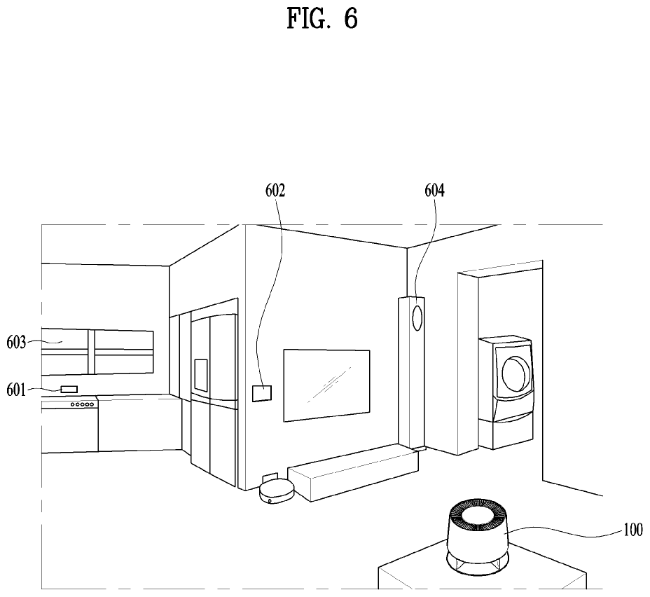

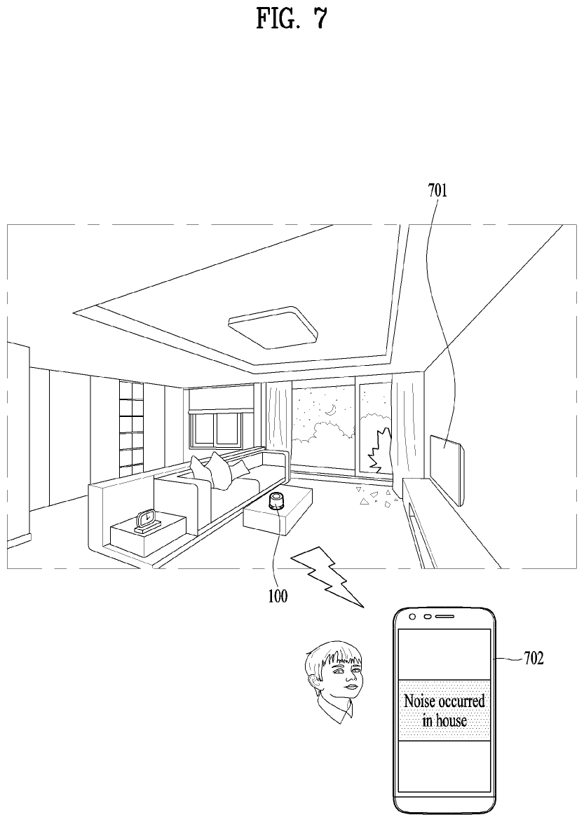

In addition, the controller 180 may transmit the control signal to the at least one linked device included in the home network based on the changed mode (S550). In this regard, a description will be described with reference to FIGS. 6 and 7.

Further, although not shown in FIG. 5, when the non-natural language audio data is additionally received after the setting mode of the home network is changed, the artificial intelligence unit 130 may change to return to the setting mode before the changed setting mode or set to maintain the changed setting mode.

FIG. 6 illustrates an example of controlling at least one device based on non-natural language audio data through an audio device according to one embodiment of the present disclosure.

Referring to FIG. 6, a device linked with the audio device 100 through the home network may include a gas circuit breaker 601, a temperature controller 602, a window 603, and an air conditioner 604. In addition, it is obvious that the devices included in the home network are not limited thereto. Further, the embodiment of the present disclosure may be implemented in at least one linked device included in various spaces such as an office network and the like in addition to the home network.

The microphone of the audio device 100, which is in the always on state, may receive audio data generated inside the house for a preset time. In this connection, the audio data may correspond to the natural language audio data or the non-natural language audio data.

In addition, when the preset time has elapsed, the audio device 100 may determine the mode of the home network based on the received non-natural language audio data. The embodiment of FIG. 6 corresponds to a case in which there is no person inside the house, which may correspond to a quiet state in which no footprint sound or movement sound is received. That is, in the embodiment of FIG. 6, the non-natural language audio data received for the preset time may correspond to noise of a preset volume or below.

In addition, the audio device 100 may determine the current situation in consideration of at least one of time, temperature, and humidity in addition to the received non-natural language audio data.

In this case, the artificial intelligence unit 130 of the audio device 100 may determine that the current situation is the away mode (or the security mode) without the person. More specifically, the artificial intelligence unit 130 may predict the current situation using the information learned using the machine learning technology based on the non-natural language audio data and various information. In addition, the artificial intelligence unit 130 may change or reset the setting mode of the home network based on the predicted current situation.

In addition, the artificial intelligence unit 130 may transmit the control signal to the at least one device included in the home network based on the determined away mode (or the security mode).

For example, in the embodiment of FIG. 6, the audio device 100 may identify a state of the gas circuit breaker 701 through the wireless communication unit, and when the gas circuit breaker 701 is in an open state, transmit a control signal to change the state of the gas circuit breaker 701 to a closed state. In addition, the audio device 100 may identify a state of the temperature controller 702 through the wireless communication unit and transmit a control signal to change the state of the temperature controller 702 to the away mode (or the security mode). Thus, the temperature controller 702 may be controlled to change a temperature inside the house based on the temperature setting in the away mode.

In addition, the audio device 100 may identify a state of the window sensor 703 through the wireless communication unit, and when the window sensor 703 is in an open state, transmit a control signal to change the state of the window sensor 703 to a closed state. In addition, the audio device 100 may identify a state of the air conditioner 704 through the wireless communication unit, and when the air conditioner 704 is in operation, transmit a control signal to change the state of the air conditioner 704 to an off state.

Further, although not shown in FIG. 6, when an electric light is included in the home network, the audio device 100 may transmit a control signal to change a switch of the electric light to an off state in the away mode. In addition, when a door lock is included in the home network, the audio device 100 may transmit a control signal to change a state of the door lock to an off state in the away mode. Further, although not shown in FIG. 6, when the mode of the home network is changed, the controller 180 may change a color of the notification information of the optical output module 154b and output the notification information.

Further, after the setting mode of the home network is changed to the away mode, the audio device 100 may continue to receive the non-natural language audio data. In this connection, when the non-natural language audio data is additionally received, the artificial intelligence unit 130 may determine to maintain the setting mode of the home network or return to the previous setting mode, based on the additionally received non-natural language audio data.

That is, through the above-described embodiment, the audio device 100 may determine and control the situation of the linked home network based on the received non-natural language audio data using the artificial intelligence system even in a situation where there is no natural language command from the user.

FIG. 7 illustrates another example of controlling at least one device based on non-natural language audio data through an audio device according to one embodiment of the present disclosure.

In the embodiment of FIG. 7, a description overlapping with the embodiment of FIG. 6 will be omitted. Referring to FIG. 7, the device linked with the audio device 100 through the home network may include a television 701, but is not limited thereto. In addition, in the embodiment of FIG. 7, it is assumed that communication with a device 702 of the user located out of the home network may be established through the wireless communication unit.

The audio device 100 may receive the audio data in the always on state. In addition, when the preset time has elapsed, the audio device 100 may determine the mode of the home network based on the received non-natural language audio data and a time at which the non-natural language audio data is received. The embodiment of FIG. 7 corresponds to a state in which no person is inside the house at night, which may correspond to a state in which the noise of above the preset volume does not occur.

In this case, the artificial intelligence unit 130 may determine the current situation as the away mode (or the security mode). Alternatively, when the time when the non-natural language audio data is received is late night, the artificial intelligence unit 130 may determine the current situation as the sleep mode. Therefore, as described above with reference to FIG. 6, the artificial intelligence unit 100 may transmit the control signal corresponding to the setting of the away mode to the device included in the home network.

In one example, in a state set to the away mode (or the security mode), the audio device 100 may receive additional non-natural language audio data corresponding to noise above a preset volume. In the embodiment of FIG. 7, the additional non-natural language audio data may correspond to a sound of the window being broken, and may also include a sound of falling object, a footprint sound with a high volume, and the like. In addition, the additional non-natural language audio data may correspond to a sound of a pet (e.g., a barking sound of a dog), a sound of a vase being broken, and the like.

In this case, the artificial intelligence unit 130 may determine, based on the received non-natural language audio data, that the current situation is a case where a risk, which is an exceptional situation in the security mode, occurred. Accordingly, the artificial intelligence unit 130 may transmit the notification to the device 702 of the user through the wireless communication unit. Further, the artificial intelligence unit 130 may also transmit a control signal to automatically turn on the television 701 to alert a person who may be inside the house.

In addition, although not shown in FIG. 7, when the mode of the home network is changed, the controller 180 may change a color of notification information of the optical output module 154b and output the notification information.

In one example, although not shown in FIG. 7, when an abnormal opening of the door lock connected through the home network is detected or an abnormal opening of a door opening sensor is detected in the security mode, the artificial intelligence unit 130 may determine that the risk occurred. Also, in this case, the artificial intelligence unit 130 may be controlled to transmit the notification to the device 702 of the user or to be automatically connected to the police.

However, even when the additional non-natural language audio data is received, data accumulated through machine learning about the sound of the pet may be stored to determine the sound of the pet as a silence. In this case, the artificial intelligence unit 130 may not transmit the notification to the device 702 of the user even when a sound of the pet is additionally received.

Controlling the Home Network by Combining the Non-Natural Language Audio Data and the Natural Language Audio Data with Each Other

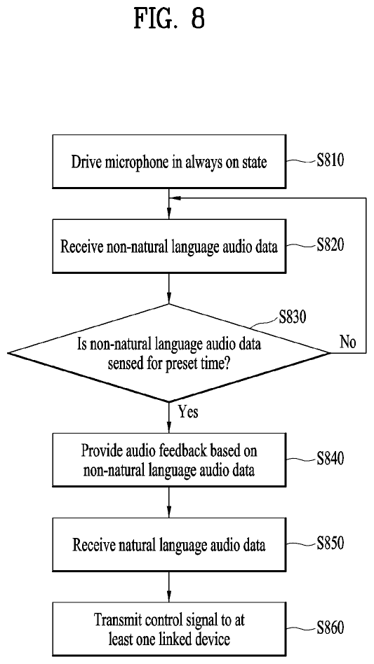

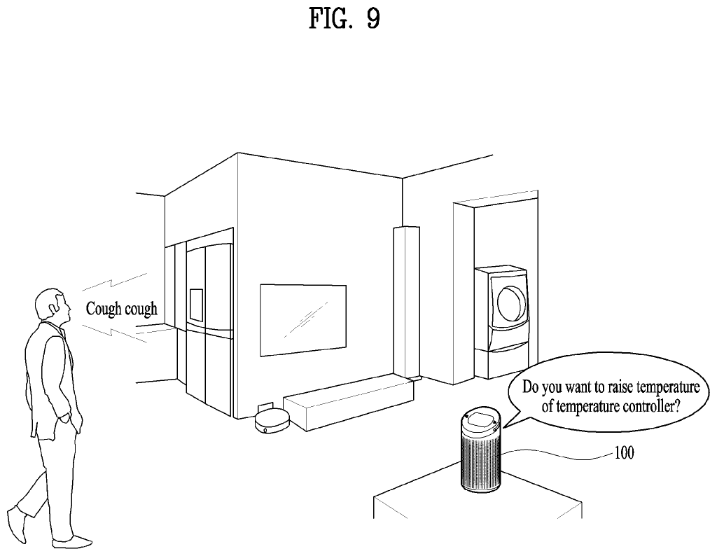

Hereinafter, in FIGS. 8 and 9, a method that determines the current situation of the home network based on the non-natural language audio data, and when the additional natural language audio data is received from the user, controls the home network based on the received additional natural language audio data will be described.

FIG. 8 is a flowchart illustrating a method for controlling an audio device according to one embodiment of the present disclosure.

In an embodiment of FIG. 8, descriptions overlapping with those of FIGS. 5 and 6 will be omitted.

First, the microphone of the audio device may be driven in the always on state (S810).

In addition, the artificial intelligence unit 130 may receive the non-natural language audio data (S820).

Next, the artificial intelligence unit 130 may determine whether the non-natural language audio data is sensed for the preset time (S830).

When the non-natural language audio data is received for the preset time, the artificial intelligence unit 130 may determine the current situation based on the non-natural language audio data and provide the audio feedback through the speaker (S840). In this regard, the artificial intelligence unit 130 may further receive at least one of current time, and temperature and humidity inside the house, as well as the non-natural language audio data, to determine the current situation. In addition, the artificial intelligence unit 130 may provide the audio feedback to the user through the speaker based on the current situation.

Thereafter, the audio device may receive the natural language audio data through the microphone (S850). In this connection, the natural language audio data corresponds to a case in which the user utters in response to the audio feedback.

In this case, the artificial intelligence unit may control the home network based on the natural language audio data (S860). For example, when the natural intelligence audio data is received, the artificial intelligence unit may extract a result through the machine learning and reflect the result in the control of the home network.

FIG. 9 illustrates an example of controlling at least one device based on non-natural language audio data and natural language audio data in an audio device according to one embodiment of the present disclosure.

In the embodiment of FIG. 9, descriptions overlapping with those described in FIGS. 6 and 7 will be omitted. Referring to FIG. 9, the device linked with the audio device 100 through the home network may include a television, an air conditioner, a robot cleaner, a refrigerator, a temperature controller, and the like. The microphone of the audio device 100, which is in the always on state, may receive various audio data generated inside the home.

In addition, when the non-natural language audio data is received for the preset time, the artificial intelligence unit 130 may determine the current situation. For example, as shown in FIG. 9, when a cough sound is received from the user, the artificial intelligence unit 130 may determine that the non-natural language audio data is received. Further, for example, when a thunder sound is received outside the window, the artificial intelligence unit 130 may determine that the non-natural language audio data is received. In this case, the artificial intelligence unit 130 may additionally receive current temperature and humidity data as well as the non-natural language audio data.

In this case, the artificial intelligence unit 130 may provide audio feedback such as ‘Do you want to raise a temperature of the temperature controller?’ through the speaker. In this regard, the artificial intelligence unit 130 may predict that the temperature inside the house should be raised when the cough sound is received, based on the information learned using the machine learning technology.

In response, when positive natural language audio data such as ‘OK’ or ‘please’ is received from the user, the artificial intelligence unit 130 may control the at least one device included in the home network based on the natural language audio data.

For example, the controller 180 may transmit a control signal for raising the temperature setting of the temperature controller to the temperature controller. In addition, when the air conditioner is turned on, the controller 180 may transmit, to the air conditioner, a control signal for raising a temperature of the air conditioner or for turning off the power of the air conditioner.

Further, the artificial intelligence unit 180 may be controlled to determine whether the user made an appointment for a hospital through the network, and when there is already the hospital appointment, output a notification associated with hospital appointment information to the user's mobile terminal (not shown) to change a date.

In addition, for example, although not shown in FIG. 9, when a thumping sound resulted by the user running on a treadmill is received as the non-natural language audio data, the artificial intelligence unit 130 may predict to lower the temperature inside the house because the user may feel hot, based on the learned information using the machine learning technology.

Thus, the artificial intelligence unit 130 may provide the audio feedback with a purpose of such as ‘Do you want to run the air conditioner?’ Or ‘Do you want to lower the temperature of the air conditioner?’ through the speaker. In response, when the positive natural language audio data is received, the artificial intelligence unit 130 may be controlled to transmit a control signal for changing the power of the air conditioner to be in an on state or for lowering the set temperature of the air conditioner.

Further, for example, although not shown in FIG. 9, when a sound of rain and a thunder sound are received as the non-natural language audio data, the artificial intelligence unit 130 may predict that the windows inside the house should be closed, based on the learned information using the machine learning technology. In this connection, the artificial intelligence unit 130 may perform the prediction by additionally sensing weather information based on geographical information of the house in addition to the sound of rain. In this connection, the controller 180 may control the dehumidifier linked with the audio device to change the switch thereof to an on state or determine whether the window is opened through the window sensor.

Therefore, the artificial intelligence unit 130 may determine whether the window is opened or closed based on data received from the window sensor included in the home network, and when the window is open, provide audio feedback of a purpose of such as ‘The window is open. Please close the window because it's showering.’.

Further, for convenience of description, the drawings are divided and described, but it may be designed that a new embodiment may be implemented by combining the embodiments respectively described in the drawings with each other.

In addition, the audio device and the method for controlling the same may not be configured such that the configurations and methods of the embodiments as described above are limited applied thereto, but may be configured by selectively combining all or some of the embodiments such that various modifications of the embodiments may be achieved.

The present disclosure described above may be embodied as computer-readable code on a medium on which a program is recorded. The computer-readable medium includes all kinds of recording devices in which data that may be read by a computer system is stored. Examples of the computer-readable media include a hard disk drive (HDD), a solid state disk (SSD), a silicon disk drives (SDD), a ROM, a RAM, a CD-ROM, a magnetic tape, a floppy disk, optical data storage, and the like. Further, the examples of the computer-readable media include a form of a carrier wave (e.g., transmission over Internet). Further, the computer may include the controller 180 of the terminal. Thus, the detailed description above should not be construed as limiting in all aspects but should be construed as illustrative. The scope of the present disclosure should be determined by reasonable interpretation of the appended claims, and all changes within the equivalent scope of the present disclosure are included in the scope of the present disclosure.

### INDUSTRIAL APPLICABILITY

The present disclosure has industrial applicability in audio devices and is able to be repeatedly applied.

What is claimed is:

1. An audio device comprising:
an artificial intelligence unit for learning history information associated with first non-natural language audio data;
a microphone for receiving the first non-natural language audio data;
a wireless communication unit for transmitting/receiving data to/from at least one device; and
a controller,
wherein the artificial intelligence unit is configured to determine a setting mode for a home network including the at least one device, in response to the received first non-natural language audio data,
wherein the controller is configured to control the wireless communication unit to transmit a control signal to the at least one device based on the determined setting mode, and
wherein the first non-natural language audio data is audio data excluding natural language audio data, and wherein the natural language audio data is language data used for human communication.

2. The audio device of claim 1, wherein the artificial intelligence unit is further configured to determine the setting mode for the home network including the at least one device when the first non-natural language audio data is received for a preset time.

3. The audio device of claim 1, wherein the artificial intelligence unit is further configured to, when second non-natural language audio data is received after the setting mode of the home network is changed, determine to cancel the changed setting mode of the home network and return to a previous home network setting mode.

4. The audio device of claim 1, wherein the artificial intelligence unit is further configured to determine the setting mode for the home network including the at least one device in response to the received first non-natural language audio data and a time when the first non-natural language audio data is received.

5. The audio device of claim 1, wherein the artificial intelligence unit is further configured to, when third non-natural language audio data is received after the setting mode of the home network is changed, transmit a notification to a mobile terminal of a user through the wireless communication unit.

6. The audio device of claim 1, wherein the artificial intelligence unit is further configured to:
learn history information associated with the non-natural language audio data corresponding to the received first non-natural language audio data; and
determine a current situation of the home network and determine the setting mode for the home network based on the history information.

7. The audio device of claim 1, wherein the artificial intelligence unit is further configured to generate audio feedback in response to the received first non-natural language audio data.

8. The audio device of claim 7, further comprising a speaker,
wherein the controller is further configured to output the audio feedback through the speaker.

9. The audio device of claim 8, wherein the artificial intelligence unit is further configured to:
receive additional natural language audio data after the audio feedback is output; and
transmit the control signal to the at least one device based on the received additional natural language audio data.

10. The audio device of claim 1, wherein the artificial intelligence unit is further configured to determine the setting mode of the home network including the at least one device based on weather information corresponding to geographical information of the home network.

11. The audio device of claim 1, wherein the microphone is driven in an always on state.

12. The audio device of claim 1, wherein the at least one device included in the home network includes at least one of a door lock, a gas lock, an air conditioner, a temperature controller, a window sensor, a hot-air blower, a television, or a lamp.

13. The audio device of claim 1, wherein the changed setting mode of the home network includes at least one of an away mode, a security mode, or a sleep mode.

14. The audio device of claim 1, further comprising an optical output module, wherein the controller is further configured to output a color of notification information corresponding to the changed setting mode of the home network through the optical output module.

15. A method for controlling an audio device, the method comprising:
learning history information associated with non-natural language audio data received from the audio device;
receiving first non-natural language audio data;
determining a setting mode for a home network including at least one device, in response to the received first non-natural language audio data; and
controlling a wireless communication unit to transmit a control signal to the at least one device based on the determined setting mode,
wherein the first non-natural language audio data is audio data excluding natural language audio data, and wherein the natural language audio data is language data used for human communication.

16. The method of claim 15, wherein the determining of the setting mode includes:
determining the setting mode for the home network including the at least one device when the first non-natural language audio data is received for a preset time.

17. The method of claim 15, further comprising, when second non-natural language audio data is received after the setting mode of the home network is changed, determining to cancel the changed setting mode of the home network and returning to a previous home network setting mode.

18. The method of claim 15, wherein the determining of the setting mode includes:
determining the setting mode for the home network including the at least one device in response to the received first non-natural language audio data and a time when the first non-natural language audio data is received.

19. The method of claim 15, further comprising:
when third non-natural language audio data is received after the setting mode of the home network is changed, transmitting a notification to a mobile terminal of a user through the wireless communication unit.

20. The method of claim 15, wherein the determining of the setting mode includes:
learning history information associated with the non-natural language audio data corresponding to the received first non-natural language audio data; and
determining a current situation of the home network and determining the setting mode for the home network based on the history information.
